(19) United States
(12) Patent Application Publication
(10) Pub. No.: US 2016/0152035 A1
(43) Pub. Date: Jun. 2, 2016

(54) Liquid Supply Unit and Liquid Supply System

(71) Applicant: Seiko Epson Corporation, Tokyo (JP)

(72) Inventors: Atsushi Kobayashi, Matsumoto-shi (JP); Satoshi Nakata, Matsumoto-shi (JP)

(21) Appl. No.: 14/948,854

(22) Filed: Nov. 23, 2015

(30) Foreign Application Priority Data
Dec. 2, 2014 (JP) 2014-243730
Aug. 7, 2015 (JP) 2015-156779

(51) Int. Cl. B41J 2/175

(52) U.S. Cl. CPC B41J 2/175

(57) ABSTRACT

A liquid supply unit adapted to be attached to a liquid ejection apparatus having a liquid introduction portion and a movable portion is provided. The liquid supply unit comprises: a housing having a liquid supply portion adapted to supply liquid to the liquid introduction portion; and an engaging portion connected to the housing in a displaceable manner, the engaging portion adapted to engage with the movable portion so as to restrict a movement of the liquid supply unit in a +Z-direction toward the liquid supply portion from the liquid introduction portion when the liquid supply unit is attached to the liquid ejection apparatus.

### BACKGROUND

1. Technical Field

The present invention relates to liquid supply units that supply liquid to liquid ejection apparatuses, and liquid supply systems.

2. Related Art

Printers are widely used as a kind of liquid ejection apparatuses, and ink cartridges are used as liquid supply units for the printers. Hitherto, various engagement mechanisms for attaching and detaching the ink cartridges to/from the printers have been proposed. For example, a technique of providing a lever serving as the engagement mechanism on a side wall of an ink cartridge is known (JP-A-2007-230249). In this known technique, upon the ink cartridge being attached to a holder, the lever of the ink cartridge engages with an engaging portion of the holder and fixed. At the time of removal, the engagement between the ink cartridge and the engaging portion is releaseed by a user pressing the lever, and the ink cartridge can be removed from the holder. JP-A-2013-141804 discloses a technique of providing a lever serving as the engagement mechanism in a holder on a carriage of a printer. In the printer described in JP-A-2013-141804, upon the ink cartridge being attached to a holder, an engaging portion of the ink cartridge engages with the lever of the holder and fixed. At the time of removal, the engagement between the ink cartridge and the lever is releaseed by a user pressing the lever, and the ink cartridge can be removed from the holder.

If the size of the lever is further reduced as with a reduction in size of ink cartridges, there is a possibility that the operability of the lever is lost. For this reason, there has been difficulty in providing a lever such as one described in JP-A-2007-230249 on a side wall of an ink cartridge in some cases. Meanwhile, even if a lever is provided in a holder on a carriage of a printer as in JP-A-2013-141804, in the case of a structure in which an ink cartridge is attached and detached by pressing a lever provided at an edge of the holder, a reduction in the size of the lever makes it difficult for a user to correctly operate the lever using the fingers. For this reason, provision of a new engagement mechanism that does not exist in known techniques has been demanded. This problem is not limited to ink cartridges for printers, but is also a problem shared by liquid supply units for other kinds of liquid ejection apparatuses.

### SUMMARY

The invention has been made in order to solve at least a part of the above-described problem, and can be achieved as the following modes or application examples.

According to one aspect of the invention is a liquid supply unit adapted to be attached to a liquid ejection apparatus having a liquid introduction portion and a movable portion. The liquid supply unit includes a housing having a liquid supply portion adapted to supply liquid to the liquid introduction portion. The liquid supply unit also includes an engaging portion connected to the housing in a displaceable manner. The engaging portion is adapted to engage with the movable portion so as to restrict a movement of the liquid supply unit in a +Z-direction toward the liquid supply portion from the liquid introduction portion when the liquid supply unit is attached to the liquid ejection apparatus.

According to this aspect, the movable portion of the liquid ejection apparatus and the engaging portion of the liquid supply unit can be engaged with each other by displacing the engaging portion of the liquid supply unit relative to the housing. Accordingly, the engaging portion and the movable portion can be engaged with each other by a new engagement mechanism that does not exist in known techniques. This configuration is advantageous for a reduction in the size of the liquid supply unit, and movement of the liquid supply unit in the first direction (+−Z-direction), i.e., the direction of removing the liquid supply unit from the liquid ejection apparatus can be easily restricted.

It is preferable that the liquid supply portion has a liquid supply port and an outer wall abutting from a surface of the housing and surrounding the liquid supply port. The reference plane may be an opening plane of the outer wall. Thereby, the liquid supply unit is lifted in the first direction (+Z-direction) at the opening plane, and movement of the liquid supply unit in the first direction (+Z-direction) can be restricted by the engaging portion engaging with the movable portion. Accordingly, the state of connection between the liquid supply portion and the liquid introduction portion can be stabilized.

It is preferable that the engaging portion has a pawl portion that moves the movable portion in the +Z-direction, the engagement portion is inserted into a recessed portion provided on the movable portion by the pawl moves the movable portion in the +Z-direction in a process of attaching the liquid supply unit to the liquid ejection apparatus. Thereby, in the liquid supply unit, the recessed portion and the pawl portion can be engaged with each other by displacing the engaging portion and the movable portion. Accordingly, movement of the liquid supply unit in the first direction (direction of removing the liquid supply unit from the liquid ejection apparatus) can be easily restricted.

It is preferable that the engaging portion has a pawl portion that moves the movable portion in +Z-direction, the engagement portion is inserted between the movable portion and a wall of the liquid ejection apparatus by the pawl moves the movable portion in the +Z-direction in a process of attaching the liquid supply unit to the liquid ejection apparatus. Thereby, in the liquid supply unit, the pawl portion can be engaged between the movable portion and the wall by displacing the engaging portion and the movable portion. Accordingly, movement of the liquid supply unit in the first direction (+Z-direction which is the direction of removing the liquid supply unit from the liquid ejection apparatus) can be easily restricted.

It is preferable that the pawl portion has an inclined face or a curved face adapted to abut against the movable portion. Alternatively, it is preferable that the pawl portion has an inclined face or a curved face adapted to abut against the wall. Thereby, in the liquid supply unit, when the engaging portion is displaced, a tip of the pawl portion can be inserted into the recessed portion or a gap between the movable portion and the wall portion and engaged therewith while causing the inclined face or the curved face to abut against the movable portion or the wall portion and moving the movable portion. Accordingly, movement of the liquid supply unit in the first direction (+Z-direction which is the direction of removing the liquid supply unit from the liquid ejection apparatus) can be easily restricted.

The liquid supply unit may further includes a biasing portion that biases the engaging portion in a +Y-toward the movable portion from the liquid supply unit in a state where the liquid supply unit is attached to the liquid ejection apparatus. It is preferable that the engaging portion has an operation portion. The engaging portion may be engaged engage with the movable portion or released from the movable portion by operation of the operation portion. Thereby, when the liquid supply unit is attached to the liquid ejection apparatus, the engaging portion can be displaced relative to the housing using the operation portion, and thereafter engaged with the movable portion using the biasing force of the biasing portion. Accordingly, movement of the liquid supply unit in the first direction (direction of removing the liquid supply unit from the liquid ejection apparatus) can be easily restricted.

It is preferable that the engaging portion has a protrusion adapted to engage with the movable portion, an operation portion adapted to operate the engage or release of the engaging protrusion to the movable portion, and a rotation fulcrum located between the protrusion and the operation portion. Thereby, when the liquid supply unit is attached to the liquid ejection apparatus, the engaging portion can be rotated relative to the housing using the operation portion to engage the protrusion with the movable portion. Accordingly, movement of the liquid supply unit in the first direction (direction of removing the liquid supply unit from the liquid ejection apparatus) can be easily restricted.

The other aspect of the invention is a liquid supply system including: the above liquid supply unit; a liquid container; and a liquid supply tube that connects the liquid supply unit to the liquid container. This mode makes it possible to eject the liquid using the liquid ejection apparatus while supplying the liquid to the liquid supply unit from the liquid container.

### BRIEF DESCRIPTION OF THE DRAWINGS

The invention will be described with reference to the accompanying drawings, wherein like numbers reference like elements.

FIG. 1 is a perspective view of a printer to which ink cartridges according to Embodiment 1 of the invention are attached.

FIG. 2 is a perspective view of an appearance of an ink cartridge as viewed obliquely from below.

FIG. 3 is a perspective view of the appearance of the ink cartridge as viewed obliquely from above.

FIG. 4 is a cross-sectional view of the ink cartridge.

FIG. 5 is a perspective view of a holder.

FIG. 6 is a cross-sectional view of the holder.

FIGS. 7A to 7C are illustrative diagrams schematically showing a process of attaching the ink cartridge to the holder.

FIGS. 8A to 8C are illustrative diagrams showing changes of the position of a first engaging portion in a process of attaching the ink cartridge to the holder.

FIGS. 9A to 9C are illustrative diagrams of tip shapes of the first engaging portion.

FIG. 10 is a cross-sectional view showing a state where the ink cartridge is attached to the holder.

FIGS. 11A to 11C are illustrative diagrams schematically showing a process of attaching an ink cartridge according to Embodiment 2 to a holder.

FIGS. 12A to 12D are illustrative diagrams schematically showing a portion at which a first engaging portion engages with a movable portion.

FIGS. 13A to 13C are illustrative diagrams schematically showing a process of attaching an ink cartridge according to Embodiment 3 to a holder.

FIGS. 14A to 14C are illustrative diagrams schematically showing a process of attaching an ink cartridge according to Embodiment 4 to a holder.

FIGS. 15A and 15B are illustrative diagrams schematically showing an ink cartridge according to Embodiment 5 and a holder.

FIG. 16 is a cross-sectional view showing a mode in which a movable portion of a rotatable lever type is provided in a holder.

FIGS. 17A to 17D are illustrative diagrams showing other modes of an ink containing chamber in an ink cartridge.

FIGS. 18A to 18F are illustrative diagrams showing other modes of an outer shell shape of an ink cartridge.

FIGS. 19A and 19B are illustrative diagrams schematically showing an ink cartridge adapted to be divided into an ink tank and an adapter.

FIG. 20 is an illustrative diagram schematically showing an ink supply system using an ink cartridge.

### DESCRIPTION OF EXEMPLARY EMBODIMENTS

Hereinafter, embodiments of a liquid supply unit and a liquid supply system to which the invention is applied will be described with reference to the drawings.

### Embodiment 1

Overall Configuration

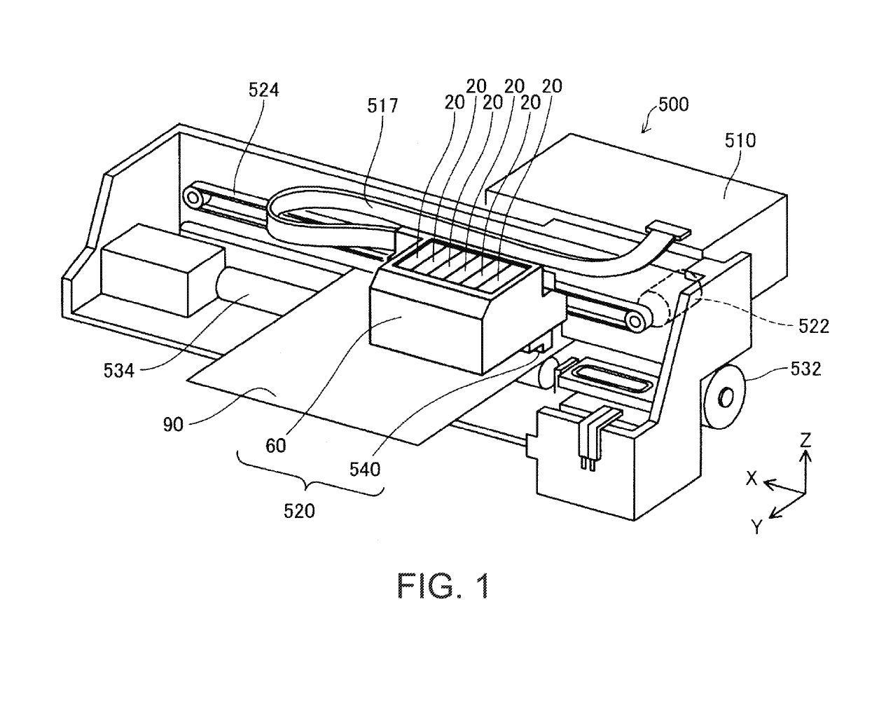

FIG. 1 is a perspective view of a printer to which ink cartridges according to Embodiment 1 of the invention are attached. A printer 500, which serves as a liquid ejection apparatus, includes a control unit 510 that controls each part of the printer 500, a carriage unit 520, a main scanning feed mechanism that moves the carriage unit 520 back and forth in a main scanning direction, and a sub-scanning feed mechanism that conveys a print medium P in a sub-scanning direction orthogonal to the main scanning feed mechanism. Ink cartridges 20, each serving as a liquid supply unit, are attached to the carriage unit 520.

In this specification, an X direction, a Y direction, and a Z direction are three directions orthogonal to one another. Regarding each of the three, namely XYZ directions shown in FIG. 1, the orientation of the arrow indicates a + direction (positive direction), and the orientation opposite to the arrow orientation indicates a − direction (negative direction). The printer 500, when in use, is arranged on an XY plane, which is a horizontal plane. At this time, the X direction is a direction parallel with the main scanning direction (the left-right direction of the printer 500) in which the carriage unit 520 is moved back and forth, and the Y direction is a direction parallel with the sub-scanning direction (the front-rear direction of the printer 500) in which the print medium P is conveyed. The Z direction is the vertical direction (the up-down direction of the printer 500), and the −Z direction is the vertically downward direction.

The carriage unit 520 includes a holder 60, which serves as a cartridge attaching portion to which the ink cartridges 20 are attached, and a print head 540 installed below the holder 60. The printer 500 in this mode is a printer of an on-carriage type in which the ink cartridges 20 are attached to the holder 60 (on-carriage holder) that constitutes the carriage unit 520. The printer 500 and the ink cartridges 20 constitute a liquid ejection system in which liquid, such as ink in the ink cartridges 20, is supplied to the print head 540 and discharged to the print medium P.

Note that a configuration may also be employed in which a stationary cartridge holder (off-carriage holder) is provided at a portion other than the carriage unit 520, and ink from the ink cartridges 20 attached to this cartridge holder is supplied to the print head 540 on the carriage unit 520 via a flexible tube. This kind of printer is called an off-carriage type.

A main scanning feed mechanism of the printer 500 includes a carriage motor 522 and a drive belt 524 that is looped in the main scanning direction, and transmits the power of the carriage motor 522 to the carriage unit 520 via the drive belt 524. A sub-scan feed mechanism includes a conveyance motor 532 and a platen roller 534, and the print medium P is conveyed using the power of the conveyance motor 532 via the platen roller 534. The carriage motor 522 and the conveyance motor 532 operate based on a control signal from the control unit 510.

The ink cartridges 20 contain ink serving as a print agent. The ink contained in the ink cartridges 20 is supplied to the print head 540 via the holder 60 to which the ink cartridges 20 are attached. A plurality of ink cartridges 20 are detachably attached to the holder 60 according to Embodiment 1. Specifically, six cartridge attachment slots to which the six types of ink cartridges can be attached in one-to-one correspondence are provided in the holder 60 in order to discharge the ink of six colors, namely black, yellow, magenta, light magenta, cyan, and light cyan. Note that the number and the type of ink cartridges 20 adapted to be attached to the holder 60 are not limited to the aforementioned number and type, and can be changed as appropriate.

The control unit 510 and the carriage unit 520 are electrically connected via a flexible cable 517. The print head 540 operates based on a control signal from the control unit 510, and discharges ink toward the print medium P. The print medium P is thereby printed.

Ink Cartridge

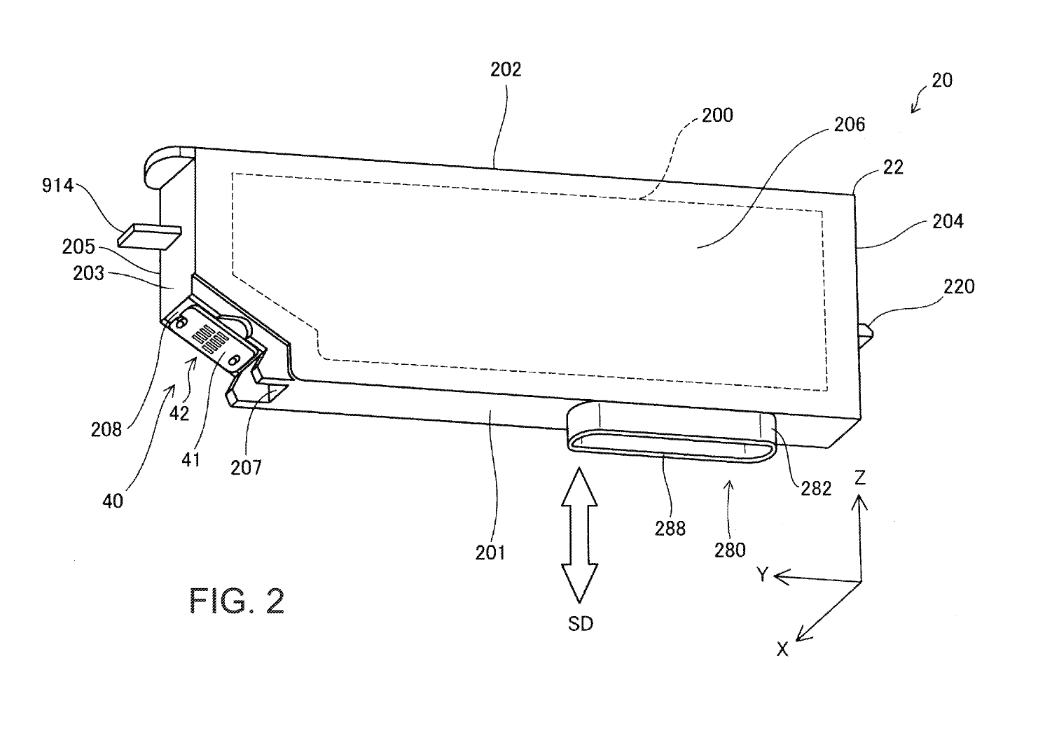

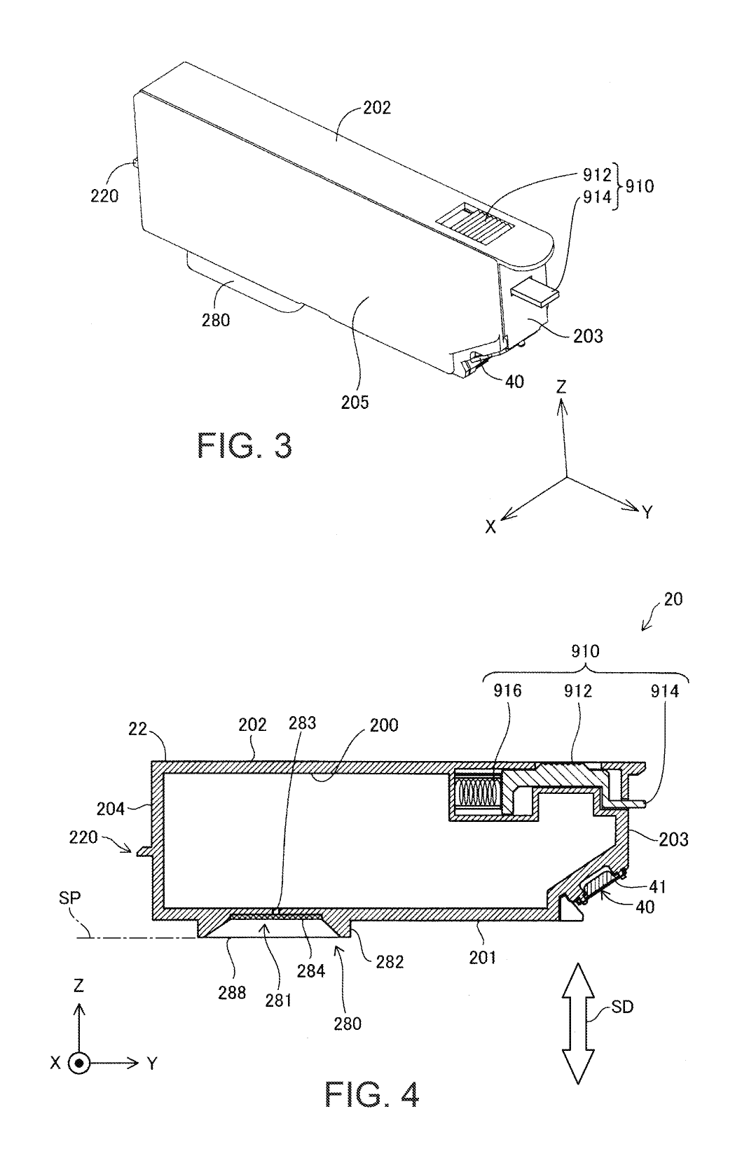

FIGS. 2 and 3 are perspective views of an appearance of the ink cartridge 20. FIG. 2 is a perspective view as viewed obliquely from below, and FIG. 3 is a perspective view as viewed obliquely from above. The ink cartridge 20 includes a housing 22, an ink supply portion 280 serving as a liquid supply portion, a terminal portion 40, a first engaging portion 914, and a second engaging portion 220. The first engaging portion 914 and the second engaging portion 220 are structures for engaging the ink cartridge 20 with the holder 60. The first engaging portion 914 is separate from the housing 22, and is connected to the housing 22 in a displaceable manner. On the other hand, the second engaging portion 220 is integrally configured with the housing 22.

An ink containing chamber 200 serving as a liquid containing chamber is formed within the housing 22. The housing 22 is made of polypropylene (PP). Note that a part of the housing 22 may be formed by a resin film. The housing 22 is substantially rectangular parallelepiped, and has a first wall 201, which is a wall face on the side in the −Z direction, a second wall 202, which is a wall face on the side in the +Z direction, a third wall 203, which is a wall face on the side in the +Y direction, a fourth wall 204, which is a wall face on the side in the −Y direction, a fifth wall 205, which is a wall face on the side in the +X direction, and a sixth wall 206, which is a wall face on the side in the −X direction. The housing 22 also has an eighth wall 208, which is an inclined face formed by cutting a corner portion at which the first wall 201 intersects the fifth wall 205, and a seventh wall 207 that connects the eighth wall 208 to the first wall 201.

The eighth wall 208 of the housing 22 is a face inclining relative to an XY plane and an XZ plane and perpendicular to a YZ plane. The terminal portion 40 includes a circuit board 41 arranged in the eighth wall 208, and a terminal group 42 placed on the circuit board 41. The terminal group 42 includes contact portions arrayed on a surface of the circuit board 41. A storage element is provided on a back side of the circuit board 41. Information regarding the ink in the ink cartridges 20 (amount of ink, ink color, etc.) is stored in the storage element. The terminal group 42 is electrically connected to the storage element.

FIG. 4 is a cross-sectional view of the ink cartridge 20. The ink supply portion 280 includes an ink supply port 281 and an outer wall 282 that surrounds the ink supply port 281. An ink flow hole 283 is formed in the ink supply port 281, and ink can pass therethrough. The outer wall 282 is a peripheral wall projecting in the −Z direction from the first wall 201, and a leading end face thereof is an opening face 288 oriented in the −Z direction. A foam resin 284 is arranged in a region surrounded by the outer wall 282 so as to cover the ink supply port 281 from the −Z direction. At the time of shipping of the ink cartridge 20, the opening face 288 of the ink supply portion 280 is sealed by a sealing member (not shown) such as a cap or a film. This sealing member is removed from the ink cartridge 20 before the ink cartridge 20 is attached to the holder 60. After the sealing member is removed, the ink containing portion 200 in the ink cartridge 20 is in communication with the outside via the ink flow hole 283 and the foam resin 284.

In the housing 22, a moving portion 910 capable of moving in the Y direction is arranged at a corner portion at which the second wall 202 is connected to the third wall 203. The moving portion 910 includes an operation portion 912 and the first engaging portion 914. The first engaging portion 914 is provided at an end portion of the moving portion 910 in the +Y direction, and projects in the +Y direction from an opening provided in the third wall 203. The operation portion 912 is provided in a face of the moving portion 910 in the +Z direction and exposed to the outside from an opening provided in the second wall 202 of the housing 22. A biasing portion 916 is arranged in the moving portion 910 on the side in the −Y direction. The biasing portion 916 is a metal spring, for example, and can bias the moving portion 910 in the +Y direction.

A large number of recesses and projections are formed on a surface of the operation portion 912. A user can easily slide the moving portion 910 in the +Y direction and the −Y direction by pressing the finger against the operation portion 912 exposed in the second wall 202. The dimension of the projection of the first engaging portion 914 from the third wall 203 thereby changes. Although the moving portion 910 is configured in which the operation portion 912 and the first engaging portion 914 are integrated members in this mode, it should be noted that the operation portion 912 and the first engaging portion 914 may be constituted by separate members.

The second engaging portion 220 is a protrusion that projects in the −Y direction from the fourth wall 204 of the housing 22. As will be described later, the first engaging portion 914 and the second engaging portion 220 engage with the holder 60 and thereby restrict movement of the ink cartridge 20 in the +Z direction.

Holder

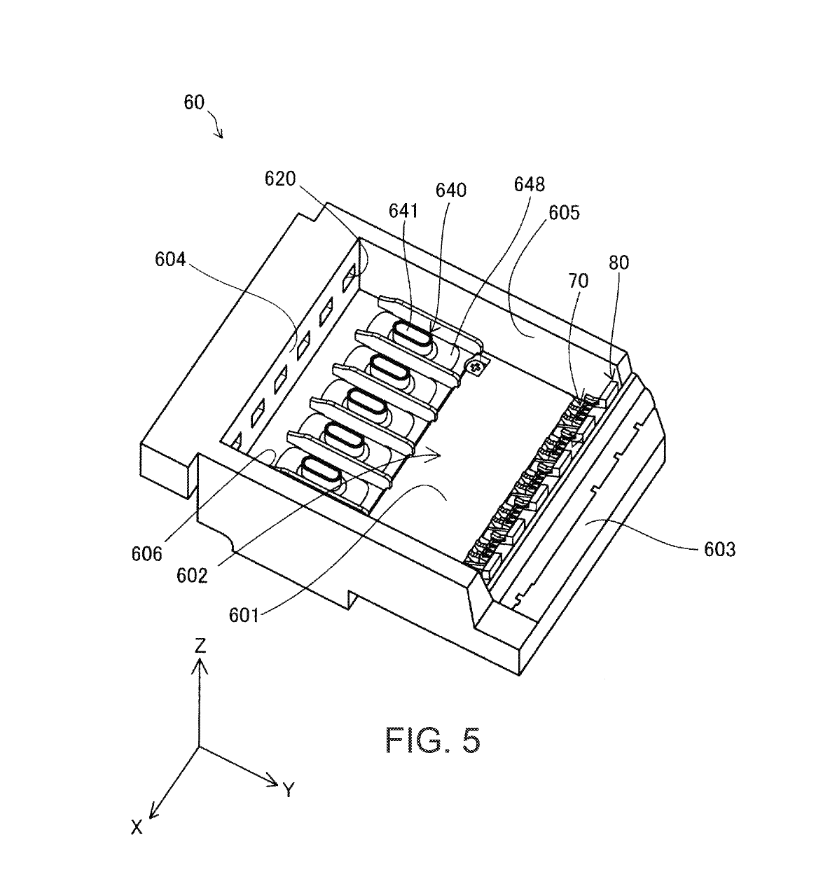

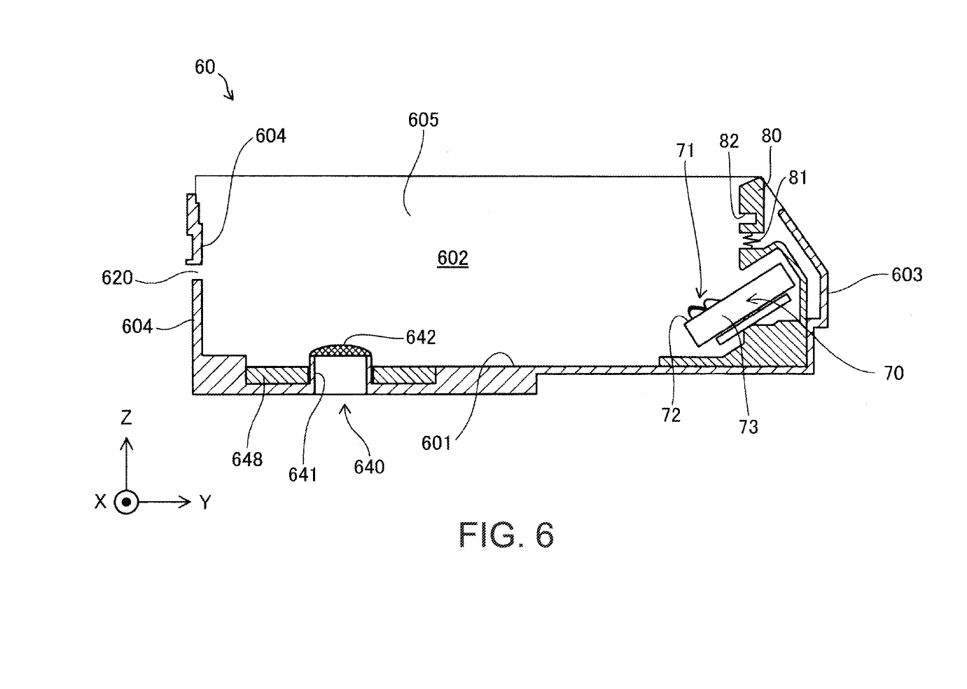

FIG. 5 is a perspective view of the holder 60, and FIG. 6 is a cross-sectional view of the holder 60. The holder 60 includes a cartridge housing portion 602 that houses the ink cartridges 20. The cartridge housing portion 602 is a recessed space surrounded by a bottom wall portion 601, a first side wall portion 603, a second side wall portion 604, a third side wall portion 605, and a fourth side wall portion 606 of the holder 60. The bottom wall portion 601 constitutes a bottom portion of the holder 60. The first side wall portion 603 and the second side wall portion 604 respectively constitute a wall face in the +Y direction and a wall face in the −Y direction of the holder 60. The third side wall portion 605 and the fourth side wall portion 606 respectively constitute a wall face in the −X direction and a wall face in the +X direction of the holder 60. These five wall portions each have a plate shape and are formed by synthetic resin.

The cartridge housing portion 602 is provided with contact point mechanisms 70 and ink introduction portions 640. The contact point mechanisms 70 are arranged inside of a corner portion at which the bottom wall portion 601 is connected to the first side wall portion 603. The ink introduction portions 640 are provided in the bottom wall portion 601. In Embodiment 1, the six ink cartridges are arranged side-by-side in the X direction to be attached to the holder 60, and accordingly six contact point mechanisms 70 and six ink introduction portions 640 are provided in the cartridge housing portion 602. The six contact point mechanisms 70 and the six ink introduction portions 640 are arranged in the X direction. The adjacent ink introduction portions 640 are partitioned by ribs. Regions demarcated in the X direction by the ribs are each a cartridge attachment slot that includes a single ink introduction portion 640.

Each contact point mechanism 70 includes a terminal group 71 in which a plurality of terminals are arranged, and a terminal base 72 that holds the terminal group 71. The terminal base 72 has an inclined face 73 that inclines relative to the bottom wall portion 601 and the first side wall portion 603, and contact portions of the terminals constituting the terminal group 71 are arranged in the inclined face 73. The terminal group 71 is biased in the direction in which the contact portions of the terminals project from the inclined face 73. When the ink cartridge 20 is attached to the holder 60, the contact portions of the terminal group 71 elastically come into contact with the contact portions of the terminal group 42 on the side of the ink cartridge 20.

Each ink introduction portion 640 includes an ink introduction port 641 and a seal portion 648 that surrounds the ink introduction port 641. The seal portion 648 can undergo elastic deformation in the Z direction. The ink introduction port 641 projects toward the inside of the cartridge housing portion 602 from the bottom wall portion 601. A mesh filter 642 is attached to a tip of the ink introduction port 641. An ink path through which the ink passes is formed in the ink introduction port 641.

The first side wall portion 603 is located at an end portion of the holder 60 in the +Y direction, and constitutes a front face of the holder 60. The holder 60 includes movable portions 80 capable of moving in the Z direction relative to the third side wall portion 605. In Embodiment 1, a biasing portion 81, such as a metal spring, is arranged between an end portion of each movable portion 80 in the −Z direction and the third side wall portion 605. The biasing portion 81 biases the corresponding movable portion 80 in the −Z direction. The movable portions 80 face the cartridge housing portion 602, and in this region, engaging recessed portions 82 each capable of engaging with the first engaging portion 914 of the corresponding ink cartridge 20 are formed.

The second side wall portion 604 is located at an end portion of the holder 60 in the −Y direction, and constitutes a back face of the holder 60. Engaging holes 620 each capable of engaging with the second engaging portion 220 of the corresponding ink cartridge 20 are formed in a region of the second side wall portion 604 that faces the cartridge housing portion 602. The engaging holes 620 are through portions that pass through the second side wall portion 604 in the Y direction.

The holder 60 is provided with engaging recessed portions 82 and the engaging holes 620, the number of engaging recessed portions 82 and engaging holes 620 corresponding to the number of ink cartridges 20 to be attached. Since the six ink cartridges 20 are attached in this mode, six movable portions 80 each including the engaging recessed portion 82 are arranged side-by-side in the X direction along the first side wall portion 603. In addition, six engaging holes 620 arranged side-by-side in the X direction are formed in the second side wall portion 604.

Attachment of Ink Cartridge

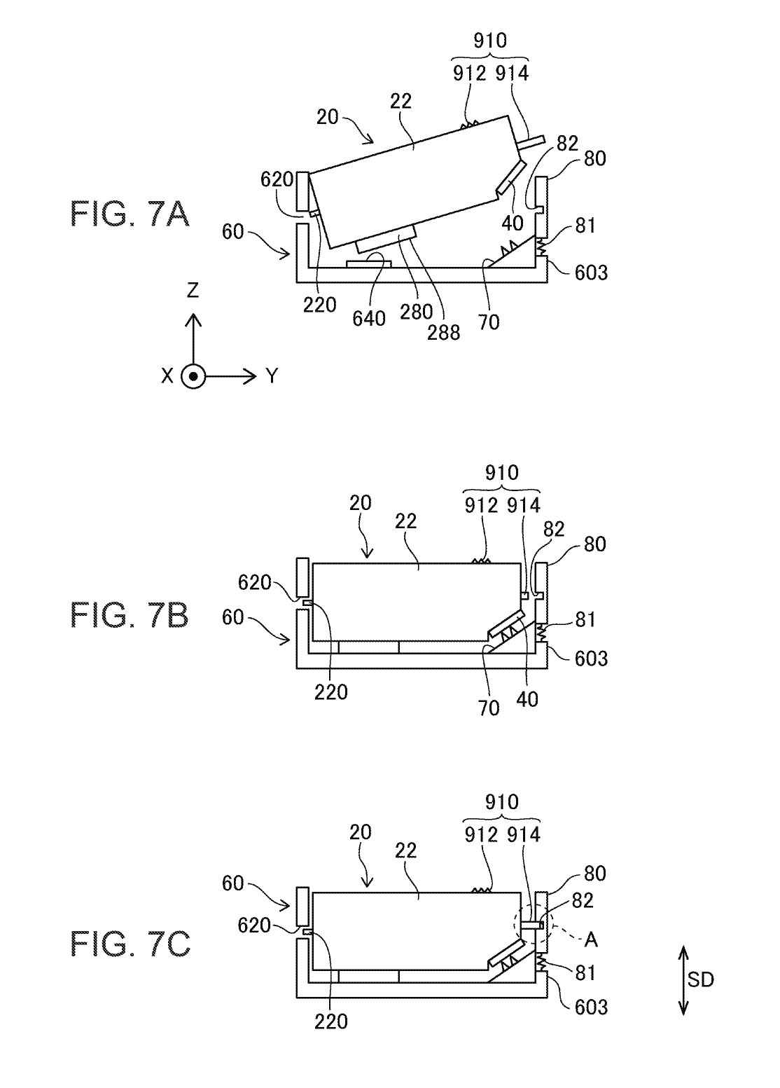

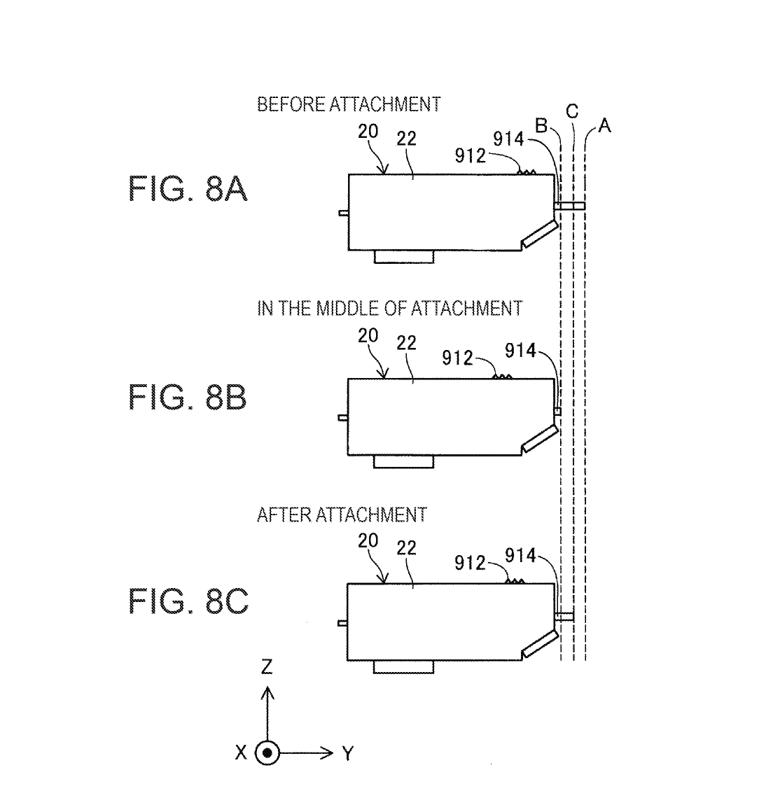

FIGS. 7A to 7C are illustrative diagrams schematically showing a process of attaching the ink cartridge 20 to the holder 60. FIGS. 8A to 8C are illustrative diagrams showing changes of the position of the first engaging portion 914 in a process of attaching the ink cartridge 20 to the holder 60. As shown in FIG. 8A, before the ink cartridge 20 is attached to the holder 60, the first engaging portion 914 of the ink cartridge 20 projects in the +Y direction from the housing 22 due to the biasing force of the biasing portion 916, and the tip of the first engaging portion 914 is located at a first position A. When the ink cartridge 20 is attached to the holder 60, initially, the ink cartridge 20 is put into the cartridge housing portion 602 in an inclined posture in which the rear end side of the ink cartridge 20 (the side of the second engaging portion 220) is lowered in the −Z direction relative to the front end side of the ink cartridge 20 (the side of the first engaging portion 914), as shown in FIG. 7A. Then, the second engaging portion 220, which is a protrusion, is inserted into the corresponding engaging hole 620 of the holder 60 to engage therewith. Note that the engaging holes 620 of the holder 60 do not need to be through portions. For example, the engaging holes 620 may be recessed portions capable of engaging with the second engaging portions 220.

Thereafter, as shown in FIG. 7B, the front end side of the ink cartridge 20 (the side of the first engaging portion 914) is lowered in the −Z direction to bring the ink cartridge 20 into a horizontal posture. At this time, the user holds down the operation portion 912 using the finger to move the moving portion 910 in the −Y direction, and withdraws the first engaging portion 914 into the housing 22. Upon the tip of the first engaging portion 914 being withdrawn up to a second position B (see FIG. 8B), the ink cartridge 20 can be put in a horizontal posture into the cartridge housing portion 602.

Thereafter, upon the user separating the finger from the operation portion 912, the first engaging portion 914 projects in the +Y direction from the housing 22 due to the biasing force of the biasing portion 916. Thereby, the first engaging portion 914 is inserted into the engaging recessed portion 82 of the movable portion 80 and engaged therewith, as shown in FIG. 7C. At this time, the tip of the first engaging portion 914 collides with the engaging recessed portion 82 of the movable portion 80, and therefore projects up to a third position C shown in FIG. 8C. The third position C is a position on the side in the −Y direction relative to the first position A.

Note that the tip of the first engaging portion 914 may be put into the engaging recessed portion 82 of the movable portion 80 in a state of having returned to the same position as the first position A.

Thus, of the ink cartridge 20, the first engaging portion 914 engages with the engaging recessed portion 82 of the movable portion 80 at an end portion (front end portion) of the ink cartridge 20 in the +Y direction, and the second engaging portion 220 engages with the engaging hole 620 of the second side wall portion 604 at an end portion (rear end portion) of the ink cartridge in the −Y direction. Since the movable portion 80 is biased in the −Z direction by the biasing portion 81, the engaged state between the first engaging portion 914 and the engaging recessed portion 82 is stable. With these engagement structures at two positions, movement of the ink cartridge 20 in the +Z direction relative to the holder 60 is restricted.

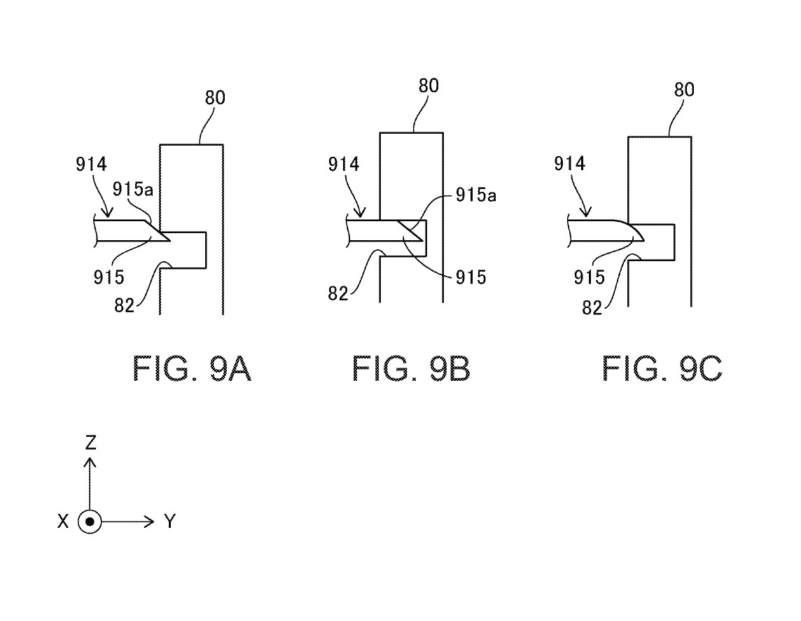

FIGS. 9A to 9C are illustrative diagrams showing tip shapes of the first engaging portion 914, and are partial enlarged views of a region A in FIG. 7C. As shown in FIG. 9A, a tapered pawl portion 915 is formed at the tip of the first engaging portion 914. When the ink cartridge 20 is attached to the holder 60, the pawl portion 915 moves the movable portion 80 and is engaged with the engaging recessed portion 82.

The pawl portion 915 includes an inclined face 915a that inclines relative to the +Y direction, which is the direction of insertion into the engaging recessed portion 82, and also inclines relative to the Z direction (+Z direction or −Z direction), which is the moving direction of the movable portion 80 with which the pawl portion 915 engages. In the example shown in FIGS. 9A to 9C, the inclined face 915a is a face that obliquely faces the upper front side (i.e., an inclined face facing in the +Y direction and the +Z direction) in a state where the ink cartridge 20 is attached to the holder 60. The inclined face 915a is an abutting face that abuts against an edge of the engaging recessed portion 82 in the +Z direction when the pawl portion 915 is inserted into the engaging recessed portion 82. Thus, with the abutting face inclining relative to the insertion direction (+Y direction), the pawl portion 915 proceeding in the +Y direction pushes up the movable portion 80 in the +Z direction. As a result, as shown in FIG. 9B, the pawl portion 915 can be deeply inserted into the engaging recessed portion 82.

The inclined face 915a may be an inclined face that obliquely faces the lower front side of the ink cartridge 20 (i.e., an inclined face facing the side in the +Y direction and the −Z direction). In this case, the inclined face 915a is an abutting face that abuts against an edge of the engaging recessed portion 82 in the −Z direction. Accordingly, when the first engaging portion 914 moves in the +Y direction, the movable portion 80 is pushed down in the −Z direction by the inclined face 915a, and the pawl portion 915 can be deeply inserted into the engaging recessed portion 82. Note that a curved face (convex curved face) as shown in FIG. 9C may be provided at the tip of the pawl portion 915. With this shape as well, an effect similar to that in the case of providing the inclined face 915a can be achieved.

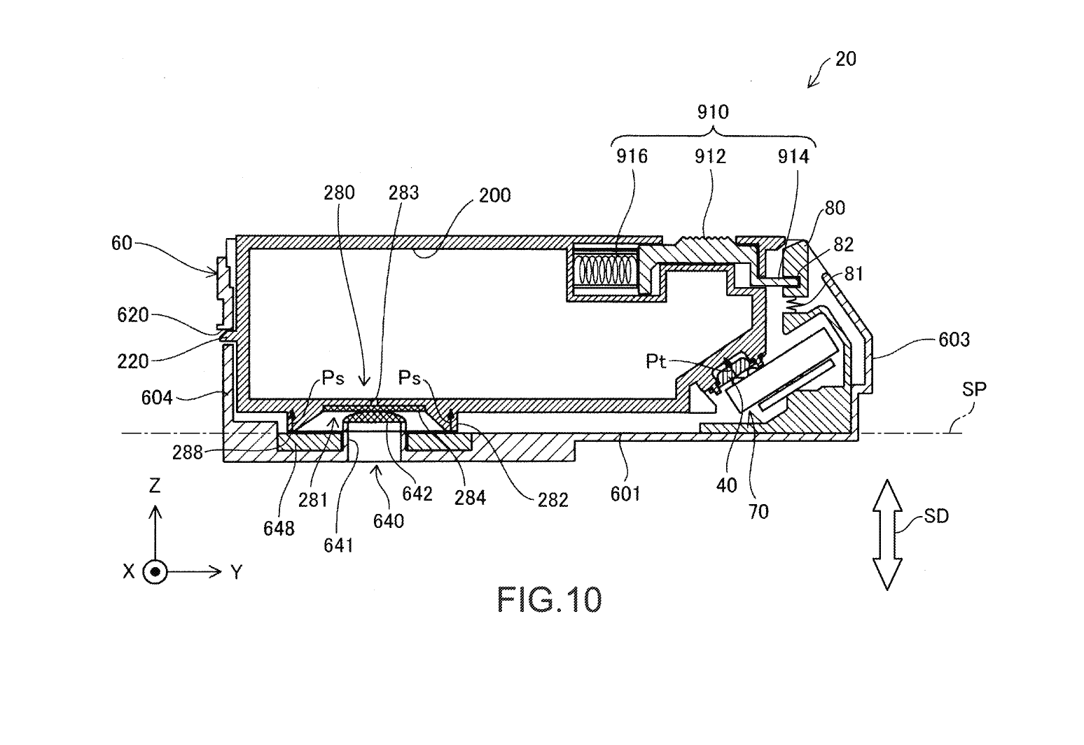

FIG. 10 is a cross-sectional view showing a state where the ink cartridge 20 is attached to the holder 60, and shows the state shown in FIG. 7C. When the ink cartridge 20 is attached to the holder 60, the ink introduction portion 640 on the side of the holder 60 faces, in the Z direction, the ink supply portion 280 on the side of the ink cartridge 20. The ink supply portion 280 includes an opening face 288, which is a leading end face of the outer wall 282 that surrounds the ink supply port 281. The opening face 288 faces in the −Z direction, and elastically comes into contact with and sticks to the seal portion 648 surrounding the ink introduction port 641. Thereby, the periphery of the ink supply port 281 and the ink introduction port 641 is tightly closed, preventing the leakage of ink. In addition, at this time, the mesh filter 642 comes into surface contact with the foam resin 284 while being pressed thereagainst. The mesh filter 642 is thereby connected to the foam resin 284.

In this specification, assuming that a plane in which the ink supply portion 280 of each ink cartridge 20 abuts against the corresponding ink introduction portion 640 of the holder 60 is a reference plane SP, and a direction in which the ink supply portion 280 abuts against the ink introduction portion 640 is an attaching direction SD, the attaching direction SD is a direction perpendicular to the reference plane SP. As mentioned above, since the opening face 288 of the ink supply portion 280 abuts against the seal portion 648 of the ink introduction portion 640, the reference plane SP corresponds to the opening face 288. When the printer 500 is in use, the opening face 288 corresponds to an XY plane, and accordingly, the reference plane SP is an XY plane and the attaching direction SD is the Z direction. Also, assuming that, of the attaching direction SD, the direction extending from the ink introduction portion 640 toward the ink supply portion 280 (i.e., the direction of removing the ink cartridge 20) is a first direction, and the direction extending from the ink supply portion 280 toward the ink introduction portion 640 (i.e., the direction of attaching the ink cartridge 20) is a second direction, the first direction is the +Z direction, and the second direction is the −Z direction.

As shown in FIG. 10, upon the ink cartridge 20 being attached to the holder 60, the opening face 288 elastically comes into contact with the seal portion 648 and receives biasing force Ps in the +Z direction (first direction) from the seal portion 648. Also, the terminal group 71 in the contact point mechanism 70 elastically comes into contact with the terminal group 42 of the circuit board 41, and the circuit board 41 receives biasing force Pt in an obliquely upward direction from the terminal group 71. These biasing forces Ps and Pt are forces in directions opposite to the second direction (−Z direction) extending from the ink supply portion 280 toward the ink introduction portion 640, and are accordingly exerted in a direction in which the ink cartridge 20 comes off from the holder 60. However, as mentioned above, the first engaging portion 914 engages with the engaging recessed portion 82 of the movable portion 80, and the second engaging portion 220 engages with the engaging hole 620 in the second side wall portion 604 in this mode. For this reason, movement of the ink cartridge 20 in the +Z direction (first direction) is restricted, and the ink cartridge 20 is positioned at the position shown in FIG. 10 against the biasing forces Ps and Pt. Accordingly, the electrical connection between the terminal group 42 of the terminal portion 40 and the terminal group 71 in the contact point mechanism 70 is stabilized. In addition, stable connection between the ink introduction portion 640 and the ink supply portion 280 can be maintained without the leakage of ink.

As described above, according to Embodiment 1, when the ink cartridge 20 is attached to the holder 60, the first engaging portion 914 of the ink cartridge 20 is displaced in the Y direction, and the pawl portion 915 provided at the tip of the first engaging portion 914 can be inserted into and engaged with the engaging recessed portion 82 of the movable portion 80 connected to the holder 60. It is thereby possible to easily restrict movement of the ink cartridge 20 in the direction (+Z direction/first direction) of removing the ink cartridge 20 from the holder 60. With this configuration, when engaging the ink cartridge 20 with the holder 60, it is not necessary to operate a lever or the like provided on the side of the holder 60. Accordingly, this embodiment is advantageous for a reduction in the size of the ink cartridge 20 and the holder 60.

### Embodiment 2

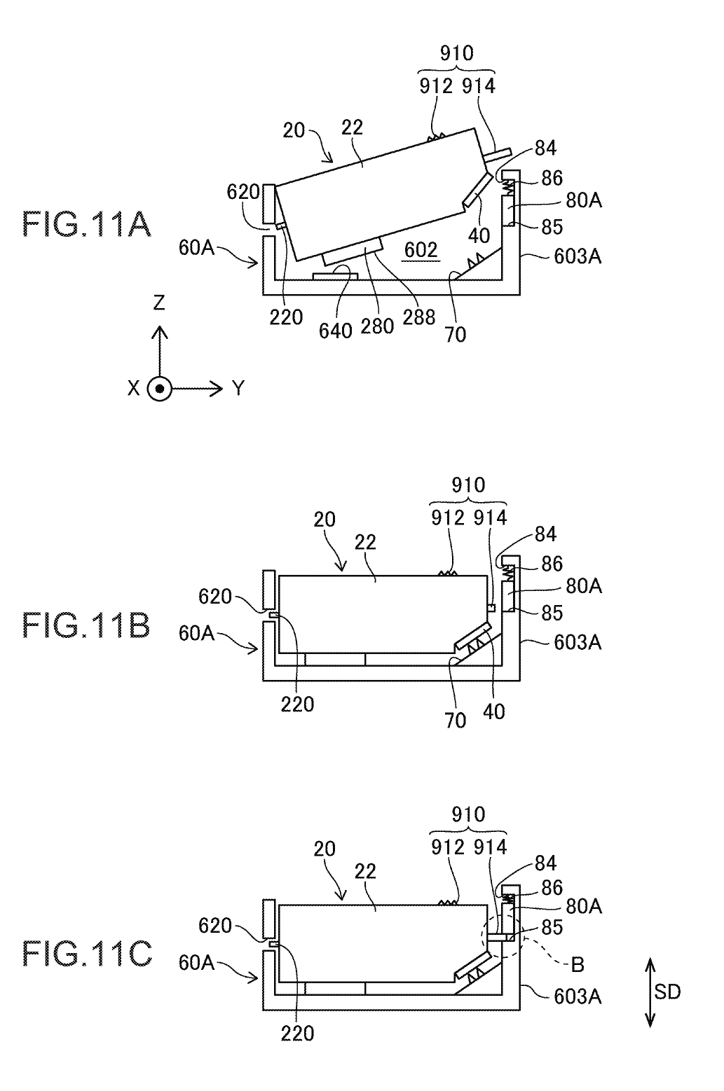

FIGS. 11A to 11C are illustrative diagrams schematically showing a process of attaching an ink cartridge 20 according to Embodiment 2 to a holder 60A. Hereinafter, the same part as that of the already-described mode will be assigned the same signs and descriptions thereof will be omitted. Only a different part will be assigned different signs and will be described. Embodiment is different from Embodiment 1 in the structure of a portion of the holder 60A that is to engage with a first engaging portion 914 of the ink cartridge 20.

The holder 60A according to Embodiment 2 includes a first side wall portion 603A, and a movable portion 80A capable of moving in the Z direction along the first side wall portion 603A. The first side wall portion 603A includes a first restricting face 84 located on the side in the +Z direction relative to the movable portion 80A, and a second restricting face 85 located on the side in the −Z direction relative to the movable portion 80A. The first restricting face 84 and the second restricting face 85 according to Embodiment 2 are inner faces of a recessed portion facing a cartridge housing portion 602, and the movable portion 80A is arranged in this recessed portion so as to be able to slide in the Z direction. A biasing portion 86, such as a metal spring, is arranged between the first restricting face 84 and the movable portion 80A. The biasing portion 86 biases the movable portion 80A in the −Z direction.

The ink cartridge 20 is attached to the holder 60A as in Embodiment 1. That is to say, as shown in FIG. 11A, a projecting second engaging portion 220 is engaged with an engaging hole 620 of the holder 60A in an inclined posture in which the rear end side of the ink cartridge 20 (the side of the second engaging portion 220) is lowered in the −Z direction relative to the front end side of the ink cartridge 20 (the side of the first engaging portion 914). Thereafter, as shown in FIG. 11B, the first engaging portion 914 of the ink cartridge 20 is drawn into the housing 22, and the ink cartridge 20 is put in a horizontal posture into the cartridge housing portion 602. Thereafter, the first engaging portion 914 is caused to project in the +Y direction from the housing 22 using the biasing force of a biasing portion 916. Thereby, as shown in FIG. 11C, the first engaging portion 914 is inserted into a gap between a lower end face of the movable portion 80A and the second restricting face 85 of the first side wall portion 603A and engaged with the holder 60A. Since the movable portion 80A is biased in the −Z direction by the biasing portion 86, the engaged state between the first engaging portion 914 and the holder 60A is stable.

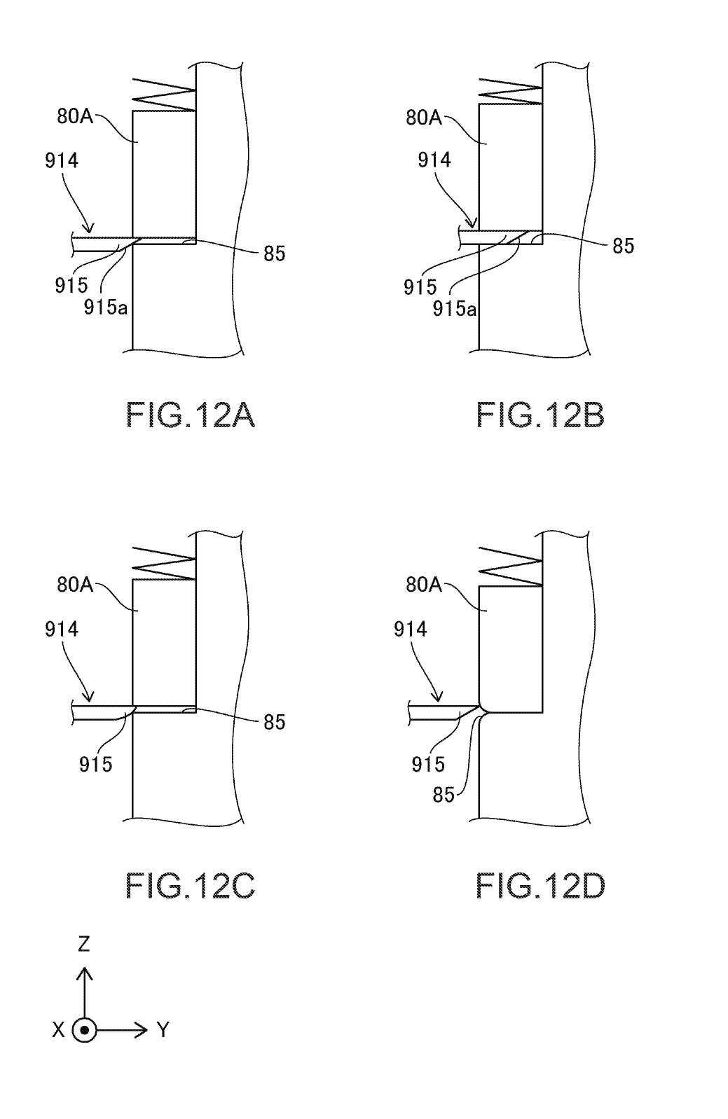

FIGS. 12A to 12D are illustrative diagrams schematically showing a portion at which the first engaging portion 914 engages with the movable portion 80A, and are partial enlarged views of a region B in FIG. 11C. At a tip of the first engaging portion 914, a pawl portion 915 is formed that includes an inclined face 915a facing in the +Y direction and the −Z direction. The inclined face 915a is an abutting face that abuts against an edge in the −Y direction of the second restricting face 85 provided in the first side wall portion 603A (see FIG. 12A) when the pawl portion 915 is inserted into the gap between the lower end face of the movable portion 80A and the second restricting face 85. Note that the inclined face 915a may be an inclined face that faces in the +Y direction and the +Z direction as in Embodiment 1, or may be a curved face as shown in FIG. 12C. With this shape, the pawl portion 915 proceeding in the +Y direction pushes up the movable portion 80A in the +Z direction. As a result, as shown in FIG. 12B, the pawl portion 915 can be deeply inserted into the engaging recessed portion 82.

In Embodiment 2, it is preferable that edges of the lower end face of the movable portion 80A and the second restricting face 85 of the first side wall portion 603A are curved faces as shown in FIG. 12D, or inclined faces. With this shape, the tip of the first engaging portion 914 can be easily engaged with the gap between the lower end face of the movable portion 80A and the second restricting face 85 of the first side wall portion 603A.

### Embodiments 3 and 4

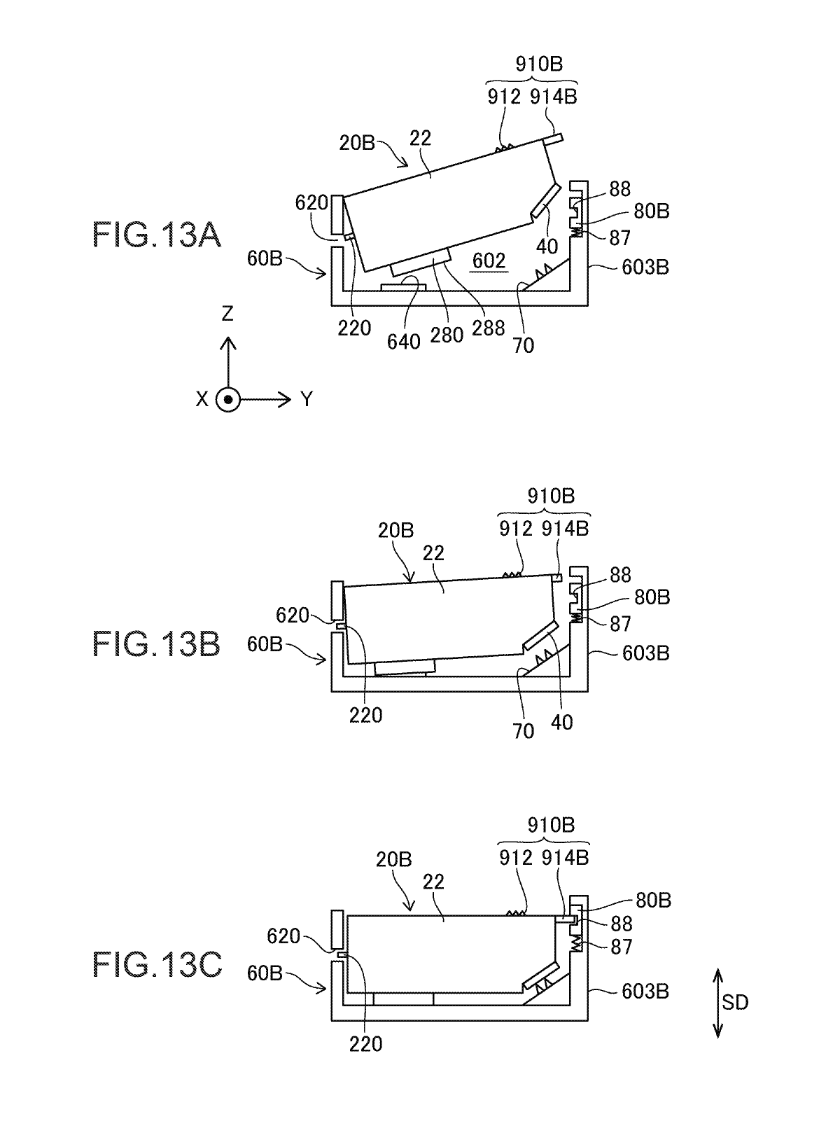

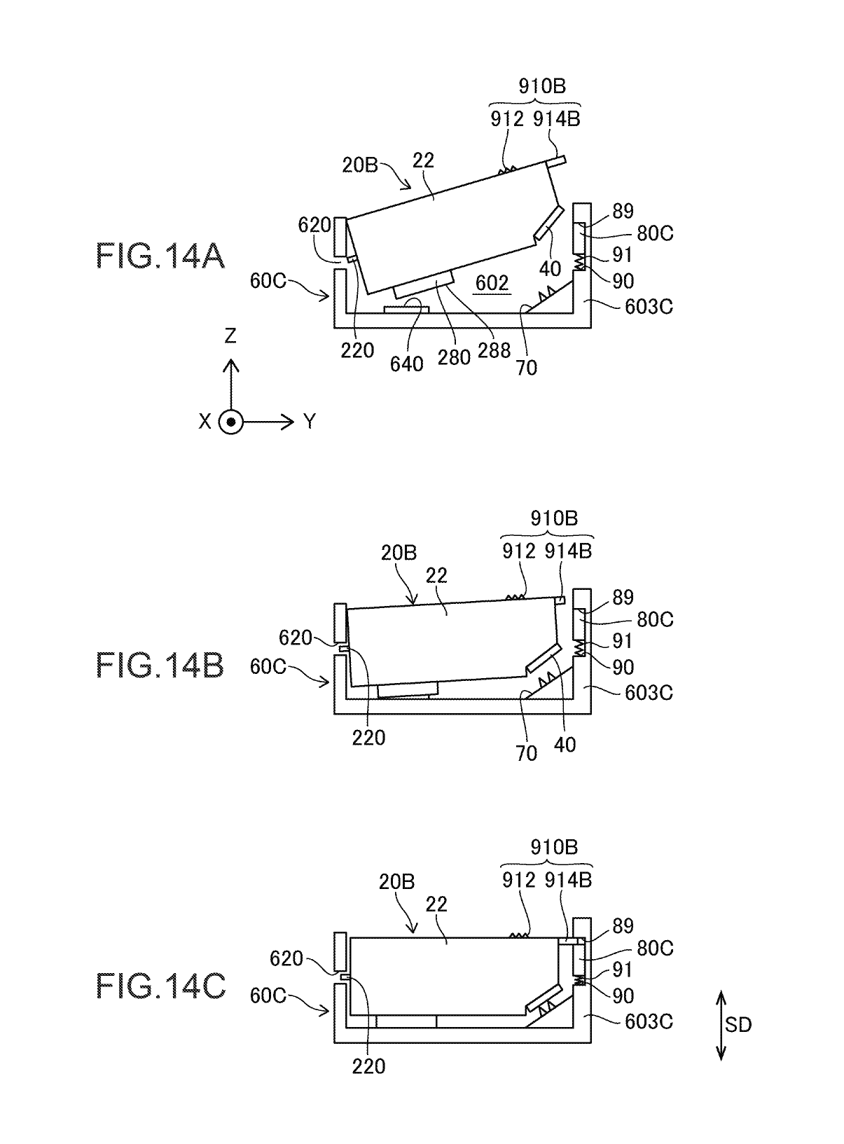

FIGS. 13A to 13C are illustrative diagrams schematically showing a process of attaching an ink cartridge 20B according to Embodiment 3 to a holder 60B. FIGS. 14A to 14C are illustrative diagrams schematically showing a process of attaching an ink cartridge 20B according to Embodiment 4 to a holder 60C. In the ink cartridge 20B according to Embodiments 3 and 4, a first engaging portion 914B is arranged at a position different from the position according to Embodiments 1 and 2. Specifically, the first engaging portion 914B projects from immediately below an upper end face of the ink cartridge 20B (i.e., a second wall 202 of a housing 22). The first engaging portion 914B is integrally formed with an operation portion 912 and constitutes a moving portion 910B.

The holder 60B according to Embodiment 3 includes a first side wall portion 603B and a movable portion 80B capable of moving in the Z direction relative to the first side wall portion 603B. A biasing portion 87, such as a metal spring, is arranged between a lower end portion (an end portion in the −Z direction) of the movable portion 80B and the first side wall portion 603B. The biasing portion 87 biases the movable portion 80B in the −Z direction. The movable portion 80B includes an engaging recessed portion 88 formed in a face facing the side of a cartridge housing portion 602, as in Embodiment 1.

The holder 60C according to Embodiment 4 includes a first side wall portion 603C and a movable portion 80C capable of moving in the Z direction along the first side wall portion 603C. The first side wall portion 603C is formed similarly to the first side wall portion 603A according to Embodiment 2, and includes a first restricting face 89 located on the side in the +Z direction relative to the movable portion 80C, and a second restricting face 90 located on the side in the −Z direction relative to the movable portion 80A. The movable portion 80C is arranged so as to be able to slide in the Z direction between the first restricting face 89 and the second restricting face 90. A biasing portion 91, such as a metal spring, is arranged between the second restricting face 90 and the movable portion 80C. The biasing portion 91 biases the movable portion 80C in the −Z direction.

The ink cartridge 20B is attached to the holder 60B/60C as in Embodiments 1 and 2. That is to say, as shown in FIGS. 13A and 14A, a projecting second engaging portion 220 is engaged with an engaging hole 620 of the holder 60B/60C in an inclined posture in which the rear end side of the ink cartridge 20B (the side of the second engaging portion 220) is lowered in the −Z direction relative to the front end side of the ink cartridge 20B (the side of the first engaging portion 914B). Thereafter, as shown in FIGS. 13B and 14B, the first engaging portion 914B of the ink cartridge 20B is drawn into the housing 22, and the ink cartridge 20B is put in a horizontal posture into the cartridge housing portion 602. Thereafter, the first engaging portion 914B is caused to project in the +Y direction from the housing 22 using the biasing force of a biasing portion 916. Thereby, the first engaging portion 914B is inserted into the engaging recessed portion 88 of the movable portion 80B and engaged therewith, as shown in FIG. 13C. Alternatively, as shown in FIG. 14C, the first engaging portion 914B is inserted into a gap between an upper end face of the movable portion 80C and the first restricting face 89 of the first side wall portion 603C and engaged with the holder 60C.

Note that, regarding any of the ink cartridges 20 and 20B described in Embodiments 1 to 4, a mode may be employed in which the first engaging portion 914/914B extends in the +Y direction from the upper end face (the second wall 202 of the housing 22) and projects in the +Y direction from the third wall 203 of the housing 22.

### Embodiment 5

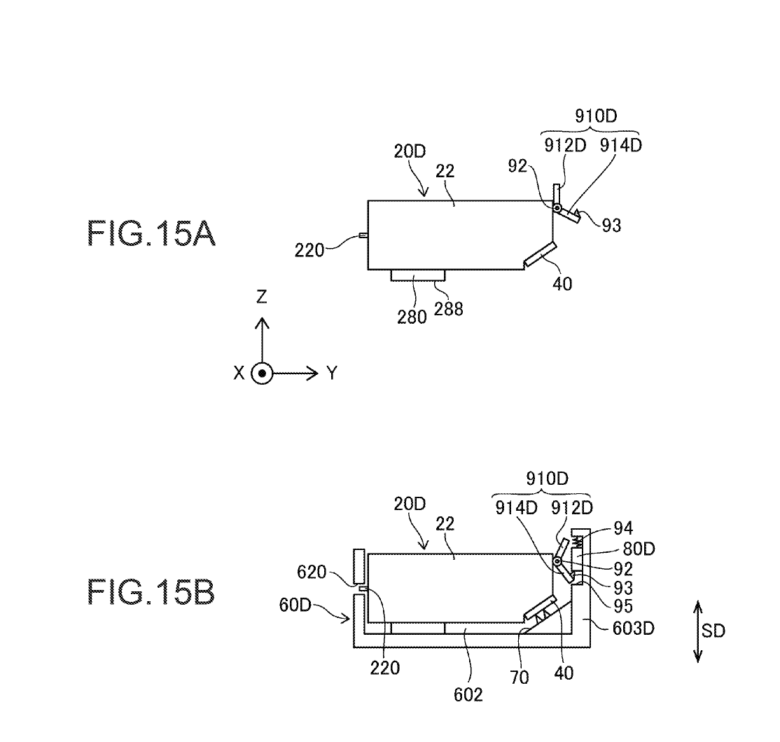

FIGS. 15A and 15B are illustrative diagrams schematically showing an ink cartridge 20D and a holder 60D according to Embodiment 5. FIG. 15A is an illustrative diagram of the ink cartridge 20D, and FIG. 15B shows a state where the ink cartridge 20D is attached to the holder 60D. The ink cartridge 20D according to Embodiment 5 includes a moving portion 910D capable of rotating relative to a housing 22. The moving portion 910D can rotate around a rotation axis parallel with the X direction with a rotation fulcrum 92 as the center, the rotation fulcrum 92 being provided at a corner portion at which a second wall 202 of the housing 22 is connected to a third wall 203 thereof (see FIG. 4). The moving portion 910D includes an operation portion 912D and a first engaging portion 914D. A protrusion 93 is provided at a tip of the first engaging portion 914D. The rotation fulcrum 92 is provided between the operation portion 912D and the protrusion 93. Note that the rotation fulcrum 92 may be provided in the second wall 202 or the third wall 203 of the housing 22.

The holder 60D includes a first side wall portion 603D that is similar to the first side wall portion according to Embodiment 2, and a movable portion 80D capable of moving in the Z direction along the first side wall portion 603D. The movable portion 80D is housed in a recessed space formed in the first side wall portion 603D and can move in the Z direction. A biasing portion 94 is arranged on the side of in the +Z direction relative to the movable portion 80D, and the biasing portion 94 biases the movable portion 80D in the −Z direction. A lower end face of the movable portion 80D faces the first restricting face 95, which is an inner face forming the recessed space in which the movable portion 80D is housed.

When the ink cartridge 20D is attached to the holder 60D, initially, a second engaging portion 220 on the rear end side of the ink cartridge 20D is engaged with an engaging hole 620 of the holder 60D, as in Embodiments 1 to 4. Thereafter, the user brings down the operation portion 912D in the +Y direction, and rotates the first engaging portion 914D in the −Z direction so as to cause the first engaging portion 914D to face downward. Then, in this state, the ink cartridge 20D is put in a horizontal posture into a cartridge housing portion 602. At this time, the protrusion 93 of the first engaging portion 914D is engaged with a gap between a lower end face of the movable portion 80D and the first restricting face 95 of the first side wall portion 603D. The first engaging portion 914D thereby engages with the holder 60D, and movement of the ink cartridge 20D in the Z direction is restricted.

Note that Embodiment 5 may employ a configuration in which a recessed portion is formed in the movable portion 80D, and the first engaging portion 914D is engaged with this recessed portion, as in Embodiments 1 and 3. The shape of the protrusion 93 may be the same as the shape of the tip of the pawl portion 915 according to Embodiment 1 and other embodiments.

Other Modes of Movable Portion

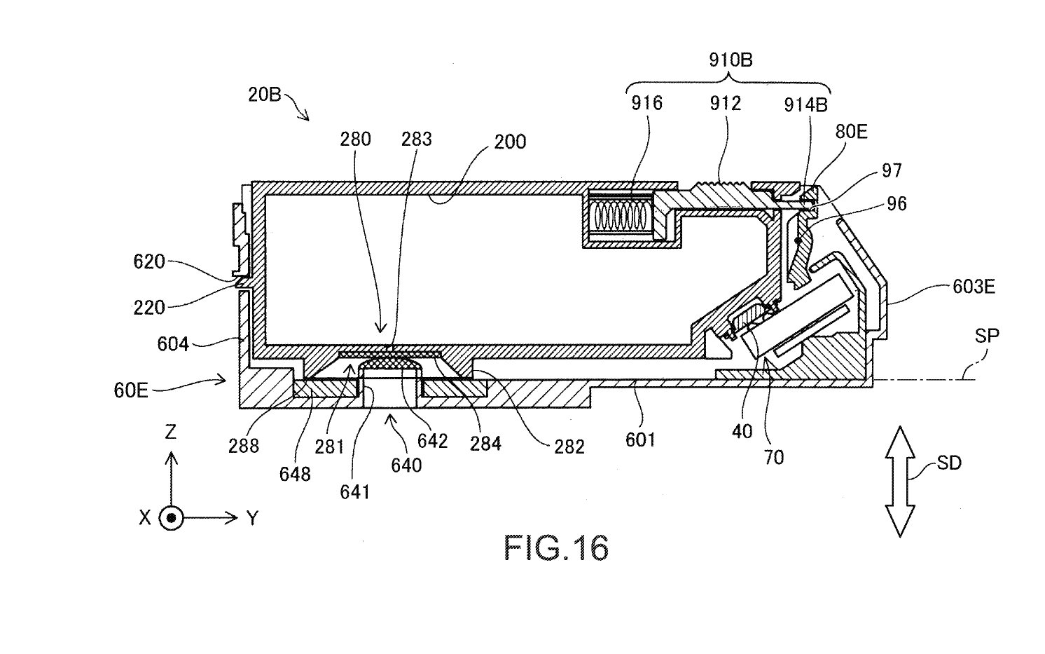

FIG. 16 is a cross-sectional view showing a mode in which a movable portion 80E of a rotatable lever type is provided in a holder 60E. In this mode, the movable portion 80E capable of rotating around a rotation axis 96 parallel with the X direction is provided in an upper part of a first side wall portion 603E of the holder 60E. The movable portion 80E includes an engaging recessed portion 97 formed in a portion extending from the rotation axis 96 to the side in the +Z direction. The ink cartridge 20B in Embodiments 3 and 4 can be attached to the holder 60E in this mode, and the first engaging portion 914B of the ink cartridge 20B can be engaged with the engaging recessed portion 97. It is thereby possible to easily restrict movement of the ink cartridge 20B in the direction (+Z direction/first direction) of removing the ink cartridge 20B from the holder 60E, as in the above embodiments. In addition, the ink cartridge 20B can be attached to the holder 60E using a new engagement mechanism that does not exist in known techniques.

Other Modes of Ink Containing Chamber

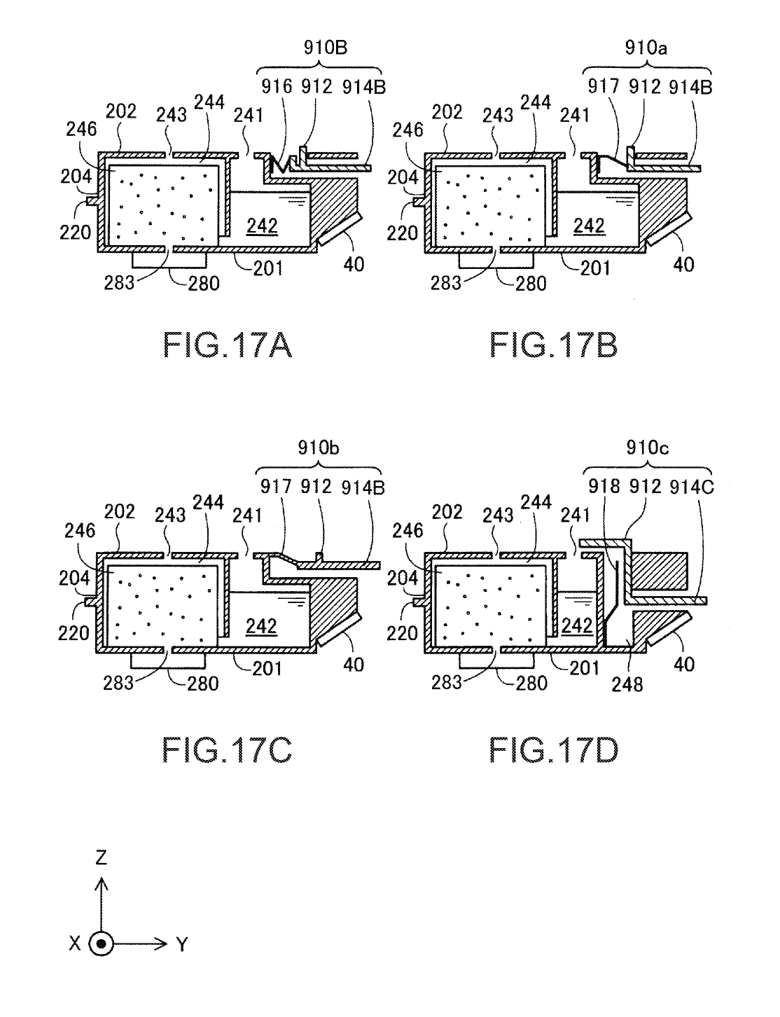

FIGS. 17A to 17D are illustrative diagrams showing other modes of an ink containing chamber in an ink cartridge. FIG. 17A shows a mode of an ink cartridge including a first engaging portion 914B similar to that of the ink cartridge 20B according to Embodiments 3 and 4. In the mode in FIG. 17A, as mentioned above, the first engaging portion 914B is integrally formed with the operation portion 912 and constitutes the moving portion 910B. A biasing portion 916 is formed by a separate spring or the like. In this mode, an ink containing chamber, which is an inside space of the ink cartridge, is demarcated into an ink storage chamber 242 and an ink supply chamber 244. The ink storage chamber 242 is located on the side of a third wall 203. An ink injection port 241 is formed above the ink storage chamber 242 in a second wall 202 of a housing 22. The ink injection port 241 is sealed with a sealing material or the like when the ink cartridge is in use. Meanwhile, the ink supply chamber 244 is located on the side of a fourth wall 204. An ink holding member 246 is arranged in the ink supply chamber 244. An atmosphere communication hole 243 is formed at a position above the ink supply chamber 244 in the second wall 202 of the housing 22. The ink supply chamber 244 is in communication with an ink flow hole 283 of an ink supply portion 280.

In FIG. 17B, a moving portion 910a including a first engaging portion 914B and a biasing portion 917 formed integrally with an operation portion 912 is provided, and the structure of an ink containing chamber is in a mode similar to the ink cartridge in FIG. 17A. The moving portion 910a is formed separately from a housing of an ink cartridge, and the biasing portion 917 undergoes elastic deformation in the Y direction and biases the first engaging portion 914B in the +Y direction.

FIG. 17C shows a mode in which a moving portion 910b including a first engaging portion 914B and a biasing portion 917 integrally formed with an operation portion 912 is integrally formed with a housing of an ink cartridge. In this mode, the structure of an ink containing chamber is similar to that in FIG. 17A. In the moving portion 910b, the biasing portion 917 connected to the housing of the ink cartridge undergoes elastic deformation in the Y direction and biases the first engaging portion 914B in the +Y direction.

In FIG. 17D, a housing chamber 248 is formed in a space surrounded by an ink storage chamber 242, a third wall 203, and a circuit board 41, and a moving portion 910c is arranged here. In this moving portion 910c, the position of a first engaging portion 914C in the Z direction is further on the side in the −Z direction than the position of the first engaging portion 914B in FIG. 17A. Specifically, the first engaging portion 914C is arranged at a position at which the distance from a first wall 201, which is a bottom face of the ink cartridge, is half or less of the height of the ink cartridge in the Z direction (i.e., the distance between the first wall 201 and the second wall 202). By thus providing the first engaging portion 914C at a low position, the state of connection between the terminal portion 40 and the contact point mechanism 70 can be further stabilized.

Other Modes of Outer Shell Shape of Ink Cartridge

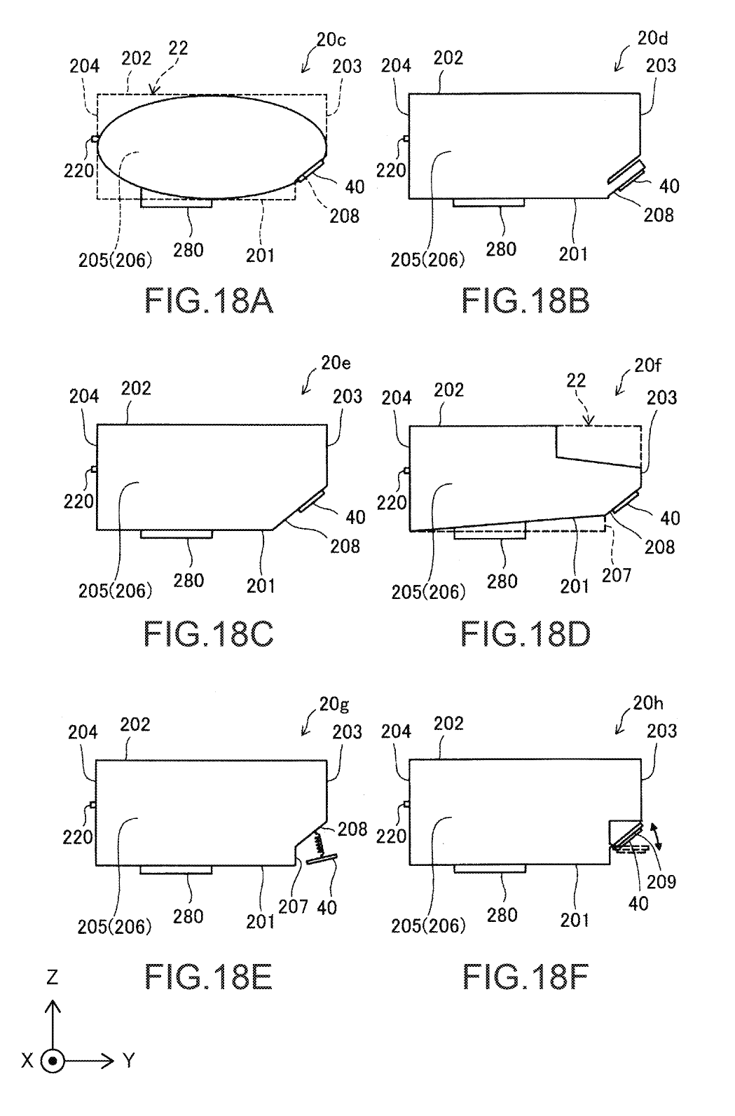

FIGS. 18A to 18F are illustrative diagrams showing other modes of the outer shell shape of an ink cartridge. Note that the configuration of a moving portion 910 including a first engaging portion 914 is within the scope described in the above modes, and accordingly FIGS. 18A to 18F omit the moving portion 910. A housing of an ink cartridge 20c shown in FIG. 18A has an elliptic or elongated circular side face, and the form thereof as viewed from the front (the form as viewed in the Y direction) has a fixed width. An ink supply portion 280 is formed in a bottom face of the ink cartridge 20c, and a terminal portion 40 is provided in an inclined face (eighth wall 208) provided on the obliquely lower side of a front face. A second engaging portion 220 is formed in a back face of the ink cartridge 20c. Note that the form indicated by broken lines in FIG. 18A is the outer shape of the housing 22 that the ink cartridge 20 according to Embodiment 1 has.

A housing of an ink cartridge 20d shown in FIG. 18B has a rectangular parallelepiped shape, whereas an eighth wall 208 provided with a terminal portion 40 is not connected to a third wall 203.

In a housing of an ink cartridge 20e shown in FIG. 18C and a housing of an ink cartridge 20f shown in FIG. 18D, an eighth wall 208 provided with a terminal portion 40 is connected to a first wall 201, and a seventh wall 207 indicated in FIG. 18D by broken lines is not provided between the first wall 201 and the eighth wall 208.

In an ink cartridge 20g shown in FIG. 18E, a terminal portion 40 is attached to an eighth wall 208 of a housing via a spring. In an ink cartridge 20h shown in FIG. 18F, a housing includes a movable wall 209, and a terminal portion 40 is attached to the movable wall 209.

Mode of Separable Ink Containing Portion

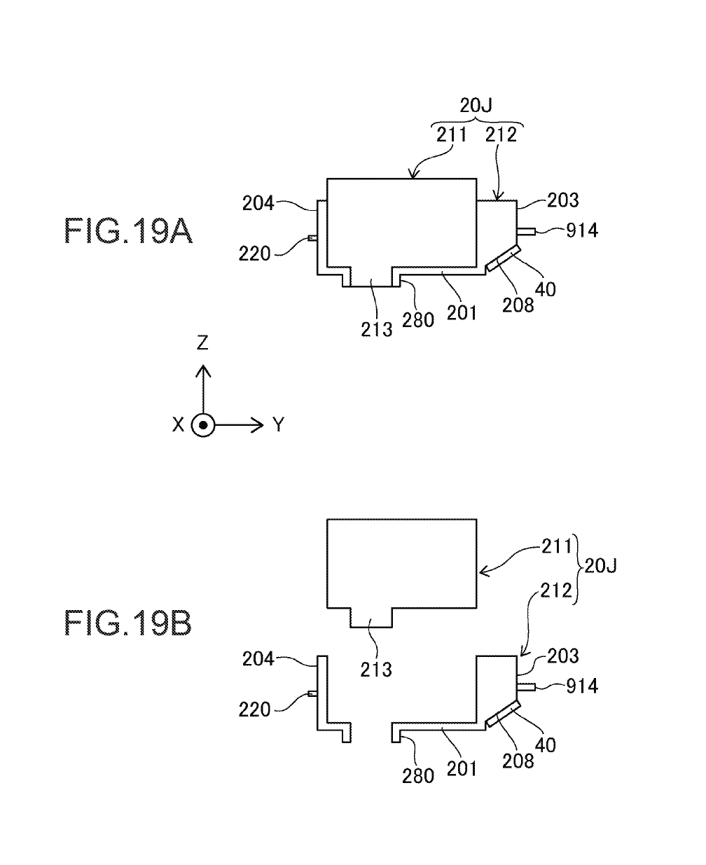

FIGS. 19A and 19B are illustrative diagrams schematically showing an ink cartridge 20J adapted to be divided into an ink tank 211 and an adapter 212. FIG. 19A shows a state where the ink tank 211 is attached to the adapter 212, and FIG. 19B shows a state where the ink tank 211 is separated from the adapter 212. The ink tank 211 is a container in which ink is contained, and can be attached to and detached from the adapter 212. The adapter 212 includes portions constituting at least the first wall 201, the third wall 203, the fourth wall 204, and the eighth wall 208 of the wall portions constituting the housing 22 of the ink cartridge 20 according to Embodiment 1 described above. An ink supply portion 280 is provided in the first wall 201 constituting a bottom portion of the adapter 212, a terminal portion 40 is provided in the eighth wall 208, a second engaging portion 220 is provided in a fourth wall 204, and a first engaging portion 914 is provided in a third wall 203. Accordingly, the adapter 212 can be attached to and detached from a holder 60, as in the above modes, in a state where the ink tank 211 is attached to the adapter 212.

A tank-side supply portion 213 that is to be connected to the ink supply portion 280 is provided in a bottom portion of the ink tank 211. With the ink cartridge 20J, ink in the ink tank 211 can be supplied to an ink introduction portion 640 of the aforementioned holder 60 via the tank-side supply portion 213 and the ink supply portion 280 in a state where the ink tank 211 is attached to the adapter 212.

Mode of Ink Supply System Including External Tank

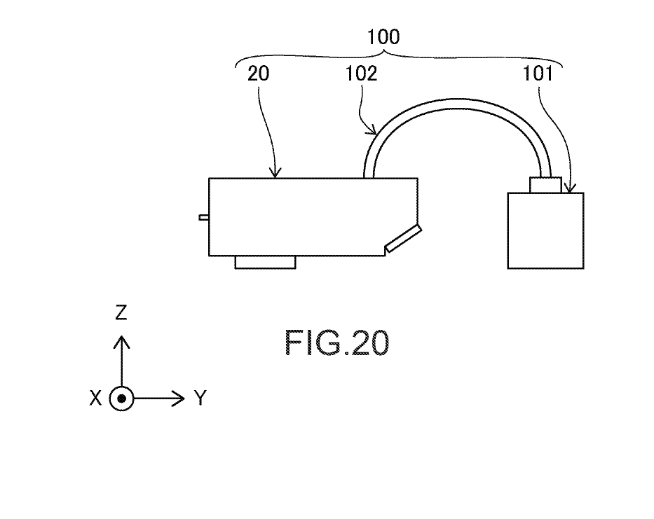

FIG. 20 is an illustrative diagram schematically showing an ink supply system 100 using an ink cartridge 20. An ink supply system 100, which serves as a liquid supply system, includes an ink cartridge 20, an external tank 101 that contains ink serving as liquid, and a flexible tube 102 serving as a liquid supply tube that connects the ink cartridge 20 to an external tank 101. The external tank 101 is installed outside the printer 500. For example, a stationary tank holder may be installed outside the printer 500, and the external tank 101 may be set in this tank holder.

In the ink supply system 100, ink in the external tank 101 can be supplied to the ink cartridge 20 via the flexible tube 102. Accordingly, upon the ink cartridge 20 being attached to the holder 60 in the aforementioned printer 500, the ink in the external tank 101 can be supplied to an ink introduction portion 640 of the holder 60 via the ink cartridge 20 to perform printing in the printer 500. In this mode, the ink cartridge 20 does not need to be replaced when ink runs short, and the external tank 101 need only be replaced, or the ink need only be supplied to the external tank 101. Accordingly, the size of the ink cartridge 20 can be reduced. Note that in the case of a printer 500 to which a plurality of ink cartridges 20 are attached, some of the plurality of ink cartridges 20 can be connected to the external tank 101 using the flexible tube 102.

As described above, the configuration of the first engaging portion 914 and the movable portion 80 of the ink cartridge 20, the configuration of the ink containing portion, the configuration of the housing 22, and the like according to Embodiment 1 can be modified in various manners as described in Embodiment 2 and the subsequent embodiments. With any of the above configurations, an effect similar to the above-described effect of Embodiment 1 can be achieved. That is to say, upon the ink cartridge being attached to the holder, movement of the ink cartridge in the +Z direction relative to the holder is restricted by the engagement structures at two portions, namely the front end and the rear end of the ink cartridge. Thereby, the electrical connection between the ink cartridge and the holder is stabilized, and the leakage of ink is also prevented. One of the engagement structures at two portions is a structure with which the engaging portion of the ink cartridge is displaced and engaged with the movable portion on the holder side. Accordingly, the engaged state is stabilized.

Note that the configurations in the above-described modes may be combined as appropriate in accordance with the purpose or usage. The invention is applicable not only to inkjet printers and ink cartridges thereof, but also to various liquid ejection apparatuses that eject various kinds of liquid including ink and liquid supply units to be attached to and detached from holders of the liquid ejection apparatuses. For example, the invention is applicable to image forming apparatuses such as a facsimile. Here, ink includes general water-based ink and oil-based ink, as well as various liquid compositions such as gel ink and hot melt-ink. The invention is also applicable to liquid supply units used in apparatuses that eject color materials used in manufacturing of color filters, apparatuses that eject electrode materials, apparatuses that eject various samples, apparatuses that eject lubricating oil, apparatuses that eject resin liquid, apparatus that eject etchant, and the like.

The entire disclosure of Japanese Patent Applications, No. 2014-243730 filed Dec. 2, 2014 and No. 2015-156779 filed Aug. 7, 2015, are expressly incorporated by reference herein.

What is claimed is:

1. A liquid supply unit adapted to be attached to a liquid ejection apparatus having a liquid introduction portion and a movable portion, the liquid supply unit comprising:
a housing having a liquid supply portion adapted to supply liquid to the liquid introduction portion; and
an engaging portion connected to the housing in a displaceable manner, the engaging portion adapted to engage with the movable portion so as to restrict a movement of the liquid supply unit in a +Z-direction toward the liquid supply portion from the liquid introduction portion when the liquid supply unit is attached to the liquid ejection apparatus.

2. The liquid supply unit according to claim 1,
wherein the liquid supply portion has a liquid supply port and an outer wall abutting from a surface of the housing and surrounding the liquid supply port, and the reference plane is an opening plane of the outer wall.

3. The liquid supply unit according to claim 1,
wherein the engaging portion has a pawl portion that moves the movable portion in the +Z-direction, the engagement portion is inserted into a recessed portion provided on the movable portion by the pawl moves the movable portion in the +Z-direction in a process of attaching the liquid supply unit to the liquid ejection apparatus.

4. The liquid supply unit according to claim 3,
wherein the pawl portion has an inclined face or a curved face adapted to abut against the movable portion.

5. The liquid supply unit according to claim 1,
wherein the engaging portion has a pawl portion that moves the movable portion in +Z-direction, the engagement portion is inserted between the movable portion and a wall of the liquid ejection apparatus by the pawl moves the movable portion in the +Z-direction in a process of attaching the liquid supply unit to the liquid ejection apparatus.

6. The liquid supply unit according to claim 5,
wherein the pawl portion has an inclined face or a curved face adapted to abut against the wall.

7. The liquid supply unit according to claim 1, further comprising:
a biasing portion that biases the engaging portion in a +Y-direction toward the movable portion from the liquid supply unit in a state where the liquid supply unit is attached to the liquid ejection apparatus.

7. The liquid supply unit according to claim 1,
wherein the engaging portion has an operation portion, the engaging portion is engaged engage with the movable portion or released from the movable portion by operation of the operation portion.

8. The liquid supply unit according to claim 1,
wherein the engaging portion has a protrusion adapted to engage with the movable portion, an operation portion adapted to operate the engage or release of the engaging protrusion to the movable portion, and a rotation fulcrum located between the protrusion and the operation portion.

9. A liquid supply system comprising:
a liquid supply unit according to claim 1;
a liquid container; and
a liquid supply tube that connects the liquid supply unit to the liquid container.
